(19) United States
(12) Patent Application Publication
(10) Pub. No.: US 2011/0276449 A1
(43) Pub. Date: Nov. 10, 2011

(54) System and Method for Determining Copyright Infringement and Collecting Royalties

(76) Inventors: Thomas Ducan Funderburk, Malibu, CA (US); Duane O. Bentzen, Calabasas, CA (US)

(21) Appl. No.: 13/103,616

(22) Filed: May 9, 2011

Related U.S. Application Data
(60) Provisional application No. 61/332,277, filed on May 7, 2010.
(60) Provisional application No. 61/366,157, filed on Jul. 21, 2010.

(51) Int. Cl. G06Q 30/00

(52) U.S. Cl. 705/34

(57) ABSTRACT

The present invention describes methods for obtaining compensation for copyright infringement wherein in one embodiment the invention comprises the steps of obtaining infringement data related to a copyright infringement; extracting infringement information from the infringement data; sending an infringement notice to an Internet Service Provider, wherein the Internet Service Provider verifies that an infringer has committed copyright infringement based upon the infringement data that was provided to the Internet Service Provider; and sending a notice to the infringer regarding the infringement information, wherein the notice includes a payment option for reconciling the copyright infringement. Additionally, the present invention discloses a computer-readable storage medium containing a set of instructions for a general purpose computer comprising the set of instructions including: obtaining infringement data; extracting infringement information from the infringement data; sending an infringement notice to an Internet Service Provider, wherein the Internet Service Provider verifies that an infringer has committed copyright infringement based upon the infringement data that was provided to the Internet Service Provider; and sending a notice to the infringer regarding the infringement information, wherein the notice includes a payment option for reconciling the copyright infringement.

### CROSS REFERENCE TO RELATED APPLICATIONS

This application claims the benefit of U.S. Provisional Patent Application No. 61/332277, filed on May 7, 2010 and U.S. Provisional Patent Application No. 61/366157, filed on Jul. 21, 2010, both of which are hereby incorporated by reference in their entirety.

### FIELD OF THE INVENTION

Various exemplary embodiments relate generally to an apparatus and method of providing a legitimate means for Internet users to download copyrighted digital content and to pay royalties for copyrighted material that was downloaded in the past without paying any fee.

### BACKGROUND OF THE INVENTION

Over the last several years, technologies have developed that make it inexpensive and easy to record, distribute, and share music via the Internet. Many artists now digitally record songs, movies, articles, or books to sell through online retailers. The evolution in technology has enabled many people to circumvent copyright law and obtain copyrighted music, movies, videos games, and other digital content written material free of cost. Individuals who obtain digital content, whether legitimately or by circumventing copyright laws, often share them with others by using free or low-cost software or Internet programs, known as “file-sharing programs.” File-sharing programs allow users to exchange digital files, including digital recordings, with each other through the Internet and between hand held mobile devices.

Most digital recordings released in the United States, however, are copyright protected, and the copyright owners do not authorize sharing through file-sharing programs. A number of companies that have distributed file-sharing programs, including the distributors of the programs Napster, Kazaa, Morpheus, Grokster, BearShare, FrostWire, and LimeWire have faced liability for copyright infringement, on the ground that they facilitated infringement committed by users of their programs. On Oct. 27,2010, LimeWire LLC , one of the world's most popular peer-to-peer file-sharing websites, was shut down after a four-year legal battle with the Recording Industry Association of America (RIAA). A federal court in New York issued a permanent injunction against LimeWire, ruling that the platform intentionally caused a “massive scale of infringement” by permitting the sharing of thousands of copyrighted works by its 50 million monthly users. A federal judge found LimeWire guilty of assisting users in committing copyright infringement “on a massive scale.” See also, A&M Records, Inc. v. Napster, Inc., 239 F.3d 1004 (9th Cir. 2001); see also Arista Records LLC et al. v. Lime Wire LLC, Case No. 06-Cv-05936 (S.D.N.Y).

These companies facilitated copyright infringement by using file-sharing programs that utilized “peer-to-peer” (“P2P”) technology. Napster, Inc. was one of the first companies to develop a file-sharing program that permitted users to make free copies of copyrighted music. The vast majority of files that were shared through the Napster program were digital recordings protected by copyright, the sharing of which was not authorized. Napster was found liable of contributory and vicarious copyright infringement. The unauthorized free-music version of the Napster program was shut down by a court-ordered injunction. Although P2P networks have many legitimate file-sharing uses, they are also used ubiquitously for copyright infringement.

The Digital Millennium Copyright Infringement Act

On Oct. 12, 1998, the U.S. Congress passed the Digital Millennium Copyright Act (“DMCA”), ending many months of turbulent negotiations regarding its provisions. Two weeks later, on October 28th, President Clinton signed the Act into law. The Act is designed to implement the treaties signed in December 1996 at the World Intellectual Property Organization (WIPO) Geneva conference, but also contains additional provisions addressing related matters. According to the DMCA, an Internet Service Provider (“ISP”) cannot be held liable for acts of copyright infringement committed by its customers so long as it is unaware of the copyright infringement. 17 U.S.C. §510(c). This provision of the DMCA is known as the “Safe Harbor” provision.

Once an ISP has notice that one of its customers has been using the Internet services it provides to infringe copyrights, it must act “expeditiously to remove, or disable access to, the [copyrighted] material.” 17 U.S.C. §501(c)(1)(A)(iii). The ISP must also respond “expeditiously to remove, or disable access to, the material that is claimed to be infringing or to be the subject of infringing activity.” 17 U.S.C. §501(c)(1)(C). In a case brought by Viacom against YouTube, the Court held, if an ISP has actual knowledge of specific instances of infringement, it cannot qualify for the Safe Harbor provisions of the DMCA. Viacom Int'l Inc. v. YouTube, Inc., Case No. 07-CV-2103 (Summary Judgment Order Jun. 23, 2010).

In terms of the information that must be provided to an ISP such that its obligation to take steps to disable access to the copyrighted material is triggered, a notice “must be a written communication provided to the designated agent of a service provider that includes substantially the following:

(i) A physical or electronic signature of a person authorized to act on behalf of the owner of an exclusive right that is allegedly infringed.

(ii) Identification of the copyrighted work claimed to have been infringed, or, if multiple copyrighted works at a single online site are covered by a single notification, a representative list of such works at that site.

(iii) Identification of the material that is claimed to be infringing or to be the subject of infringing activity and that is to be removed or access to which is to be disabled, and information reasonably sufficient to permit the service provider to locate the material.

(iv) Information reasonably sufficient to permit the service provider to contact the complaining party, such as an address, telephone number, and, if available, an electronic mail address at which the complaining party may be contacted.

(v) A statement that the complaining party has a good faith belief that use of the material in the manner complained of is not authorized by the copyright owner, its agent, or the law.

(vi) A statement that the information in the notification is accurate, and under penalty of perjury, that the complaining party is authorized to act on behalf of the owner of an exclusive right that is allegedly infringed.” 17 U.S.C. §501(c)(3)(A).

The DMCA allows copyright owners to recover damages ranging between $750 to $30,000 per infringement. 17 U.S.C. §504(c)(1). If the infringement is found to be willful, the copyright owner may recover $150,000 per infringement. 17 U.S.C. §504(c)(2). In addition, the copyright owner can obtain costs of suit and attorney's fees. 17 U.S.C. §505.

Peer-to-Peer Networks

Peer-to-peer (“P2P”) computing or networking is a distributed application architecture that partitions tasks or workloads between peers. See generally http://en.wikipedia.org/wiki/Peer-to-peer. Peers are equally privileged, equipotent participants in the application. They are said to form a peer-to-peer network of nodes. Id. Peers make a portion of their resources, such as processing power, disk storage or network bandwidth, directly available to other network participants, without the need for central coordination by servers or stable hosts. Id. Peers are both suppliers and consumers of resources, in contrast to the traditional client-server model where only servers supply, and clients consume. Id.

An unstructured P2P network is formed when the overlay links are established arbitrarily. Id. Such networks can be easily constructed as a new peer that wants to join the network can copy existing links of another node and then form its own links over time. Id. In an unstructured P2P network, if a peer wants to find a desired piece of data in the network, the query has to be flooded through the network to find as many peers as possible that share the data. Id. The main disadvantage with such networks is that the queries may not always be resolved. Id. Popular content is likely to be available at several peers and any peer searching for it is likely to find the same thing. Id. But if a peer is looking for rare data shared by only a few other peers, then it is highly unlikely that search will be successful. Id. Since there is no correlation between a peer and the content managed by it, there is no guarantee that flooding will find a peer that has the desired data. Id. Flooding also causes a high amount of signaling traffic in the network and hence such networks typically have very poor search efficiency. Id. All of the popular P2P networks are unstructured.

In pure P2P networks: Peers act as equals, merging the roles of clients and server. Id. In such networks, there is no central server managing the network, neither is there a central router. Id. Some examples of pure P2P application layer networks designed for peer-to-peer file sharing are Gnutella (pre v0.4) and Freenet. Id.

There also exist hybrid P2P systems, which distribute their clients into two groups: client nodes and overlay nodes. Id. Typically, each client is able to act according to the momentary need of the network and can become part of the respective overlay network used to coordinate the P2P structure. Id. This division between normal and ‘better’ nodes is done in order to address the scaling problems on early pure P2P networks. Examples for such networks are for example Gnutella (after v0.4) or G2. Id.

Another type of hybrid P2P network are networks using on the one hand central server(s) or bootstrapping mechanisms, on the other hand P2P for their data transfers. Id. These networks are in general called ‘centralized networks’ because of their lack of ability to work without their central server(s). An example for such a network is the eDonkey network (eD2k). Id.

Despite the substantial penalties levied by the DMCA for copyright infringement, there is presently widespread copyright infringement of digitally copyrighted material, e.g., music, movies, television shows, video games, books, and the like. Part of the proliferation of copyright infringement can be attributed to the use of anonymous peer-to-peer networks, which uses an overlay network to hide the physical location of each node from other participants while simultaneously allowing participants to share copyrighted data without paying the copyright owner any royalties for her work.

There are several P2P software distributors, known as clients. When you download for example Lime Wire, you download a client. As those skilled in the art will recognize, examples of some of these clients include Gnuttella, eDonkey, Ares, OpenNAP, BitTorrent, and the like.

The P2P landscape has several distinct areas: protocols, networks, access tools, software businesses, open source developers, indexing and search sites, and dark businesses. Presently, the most popular access tools are LimeWire, BitTorrent, and eMule. The corresponding protocols for these access tools are: Gnutella, BitTorrent, and eDonkey, respectively. P2P is ubiquitous because it only requires a relatively small number of individual, voluntary users anywhere in the world for its existence. There are no infrastructure requirements. The protocols are open specifications that any computer programmer can use to develop software interacting with the different P2P networks. The networks are comprised of a collection of users who have downloaded and installed one of the many free access tools.

By way of example, the torrent protocol can distribute a large file without the heavy load on the source computer and network. Rather than downloading a file from a single source, the torrent protocol allows users to join a “swarm” of hosts to download and upload from each other simultaneously. The protocol works as an alternative method to distribute data and can work over networks with low bandwidth so even small computers, like mobile phones, are able to distribute files to many recipients.

A user who wants to upload a file first creates a small torrent descriptor file that he distributes by conventional means (web, email, mobile app, etc.). He then makes the file itself available through a torrent node acting as a seed. Those with the torrent descriptor file can give it to their own torrent nodes which, acting as peers or leeches, download it by connecting to the seed and/or other peers.

The file being distributed is divided into segments called pieces. As each peer receives a new piece of the file it becomes a source of that piece to other peers, relieving the seed from having to send a copy to every peer. With torrent, the task of distributing the file is shared by those who want it; it is entirely possible for the seed to send only a single copy of the file itself to an unlimited number of peers.

Each piece is protected by a cryptographic hash contained in the torrent descriptor. This prevents nodes from maliciously modifying the pieces they pass on to other nodes. If a node starts with an authentic copy of the torrent descriptor, it can verify the authenticity of the actual file it has received. When a peer completely downloads a file, it becomes an additional seed.

This eventual shift from peers to seeders determines the overall “health” of the file (as determined by the number of times a file is available in its complete form).

The Proliferation of Copyright Infringement

This distributed nature and speed of downloading inherent in P2P networks leads to a flood-like spreading of a file throughout peers called a “swarm.” As more peers join the swarm, the likelihood of a successful download increases. Relative to standard Internet hosting, this provides a significant reduction in the original distributor's hardware and bandwidth resource costs. It also provides redundancy against system problems, reduces dependence on the original distributor and provides a source for the file that is generally temporary and therefore harder to trace than when provided by the enduring availability of a host in standard file distribution techniques. These advantages of peer-to-peer networks have enabled widespread, unauthorized distribution of copyrighted material.

Once a user downloads a torrent client, or any other of a number of clients, such as Gnutella, BearShare, etc., the user is then free to search through a vast network of copyrighted digital material, free for the taking. By way of example, a client can send a query to another network requesting a copy of a particular song. The network responds by providing the user with a list of all available versions of that song. The previous users who have downloaded that song have agreed under the terms of the P2P networks to make that song available to subsequent users. Once the requestor chooses the version of the song she would like to copy, the song is transmitted to her in numerous small files from numerous computers. The small files are reassembled in the proper order on the requestor's computer. And viola, she has illegally infringed the copyrights of the owners of the data she has just downloaded.

In trying to combat the proliferation of copyright infringement via P2P networks, the music industry, for example, has spent millions of dollars on digital rights management technologies. Many of these digital rights management solutions were embedded within the music files themselves. When sophisticated users found ways to circumvent digital rights management efforts, the music industry turned to aggressive litigation tactics to enforce its copyrights. These lawsuits were widely publicized and were negatively viewed by music fans. Even though 30,000 lawsuits were filed from 2002 to 2008 and millions of dollars were collected, P2P traffic continued to grow. In December of 2008, the Recording Industry Association of America announced that it was going to work with ISPs to stymie P2P users. Arstechnica.com Dec. 19, 2008.

Protecting the rights of copyright owners has heretofore been on an ad hoc basis. For example, copyright owners have obtained information about infringers that allows the rights-holders to determine the IP address of infringers as well as information related to what copyrights have been infringed and when they have been infringed. Once a rights-holder has this information, he can obtain a subpoena requiring an ISP to correlate the IP address of the infringer with a person. From there, the rights-holder can sue that individual or send a notice to that individual regarding the infringement and the ensuing penalties associated with copyright infringement.

These methods are undesirable for two reasons. First, suing fans creates negative sentiments among an artist's fan base. Second, sending notices of infringement without offering viable payment options has not led to a substantial recovery of royalties due to copyright owners. The International Federation of the Phonographic Industry, (“IFPI”), is the organization that represents the interests of the recording industry worldwide. In its 2008 year-end report it states 95% of all copyrighted material is downloaded royalty-free. It is therefore critical for musicians, video copyright holders, artists, film and television rights-owners, and writers to be able to, on the one hand, protect their copyrighted material, and at the same time receive fair market royalty compensation without alienating their fan base through harsh litigation.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented below.

As such, methods for obtaining compensation for copyright infringement wherein in one embodiment the invention comprises the steps of obtaining infringement data related to a copyright infringement; extracting infringement information from the infringement data; sending an infringement notice to an Internet Service Provider, wherein the Internet Service Provider verifies that an infringer has committed copyright infringement based upon the infringement data that was provided to the Internet Service Provider; and sending a notice to the infringer regarding the infringement information, wherein the notice includes a payment option for reconciling the copyright infringement.

In an alternate embodiment, the method could further comprise a step for receiving payment for the copyright infringement. A further alternate embodiment could include the step of including a payment option to reconcile the copyright infringement. A still further embodiment could include the step of determining if a copyright infringer is a repeat infringer. If the copyright infringer is a repeat infringer, an additional embodiment could comprise the step of including a warning in the infringement notice regarding willful copyright infringement.

In an additional embodiment, when an ISP has sent a notice to the infringer regarding his or her copyright infringement, the ISP could also notify the rights-holder or its agent that this notice has been sent. In this embodiment, the rights-holder or its agent could track whether the infringer has paid for the copyright infringement. In yet another embodiment, the rights-holder or its agent could send a message to the Internet Service Provider notifying it of whether it has received payment for the infringement, said message comprising either a notice to escalate collection efforts or notification that payment has been received.

Additional embodiments disclose the concept of providing myriad payment options to copyright infringers. These payment options are fan-based and include the opportunity to join a fan club, purchase artist memorabilia, tickets to artist's events, and the like in lieu of paying a royalty.

In an alternate embodiment, the present invention discloses the method of rights-holders or their agents participating in the swarm of file-sharing networks hosting copyrighted data. In this method, the rights-holder or its agent monitors the downloading of copyrighted information. Once a user violates the terms of service of their client software (all users agree not to use the torrent software for illegal proposes) by knowingly downloading this copyrighted content, he or she would be sent an infringement notice, which would extend a payment option to the infringer in lieu of potential copyright infringement litigation that could rightfully be brought under the DMCA.

In other embodiments a computer-readable storage medium containing a set of instructions for a general purpose computer is presented, the set of instructions including: obtaining infringement data; extracting infringement information from the infringement data; sending an infringement notice to an Internet Service Provider, wherein the Internet Service Provider verifies that an infringer has committed copyright infringement based upon the infringement data that was provided to the Internet Service Provider; and sending a notice to the infringer regarding the infringement information, wherein the notice includes a payment option for reconciling the copyright infringement.

In other embodiments a computer-readable storage medium containing a set of instructions for a general purpose computer is presented, the set of instructions including: establishing a file-sharing network containing copyrighted information thereon; capturing infringement data when a user downloads copyrighted information from the file-sharing network; and sending an infringement notice to the user offering a payment option in exchange for having obtained copyrighted information.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustrative overview flowchart for determining when copyright infringement has occurred and obtaining compensation for use of the copyrighted material;

FIG. 2 is an illustrative example of the data contained in a notice that could be sent to purported copyright infringers;

FIG. 3 is an illustrative example of payment options that could be provided to copyright infringers; and

FIG. 4 is an illustrative flowchart for creating a network wherein users believe that they can download copyrighted data for free but in fact, after illegally downloading copyrighted data, users are provided with payment options to pay for the copyrighted date.

### DETAILED DESCRIPTION OF THE INVENTION

The present invention will now be described in detail with reference to a few embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In particular, embodiments are described for protecting the copyrights of rights-holders in the music industry. Those skilled in the art will readily see how the description of these embodiments can be adapted to protect the copyrights of rights-holders in other digital medium, such as, video, film, television, art, photography, written works, etc.

Various embodiments are described herein below, including methods and techniques. It should be kept in mind that the invention might also cover articles of manufacture that includes a computer readable medium on which computer-readable instructions for carrying out embodiments of the inventive technique are stored. The computer readable medium may include, for example, semiconductor, magnetic, opto-magnetic, optical, or other forms of computer readable medium for storing computer readable code. Further, the invention may also cover apparatuses for practicing embodiments of the invention. Such apparatus may include circuits, dedicated and/or programmable, to carry out tasks pertaining to embodiments of the invention. Examples of such apparatus include a general-purpose computer and/or a dedicated computing device when appropriately programmed and may include a combination of a computer/computing device and dedicated/programmable circuits adapted for the various tasks pertaining to embodiments of the invention.

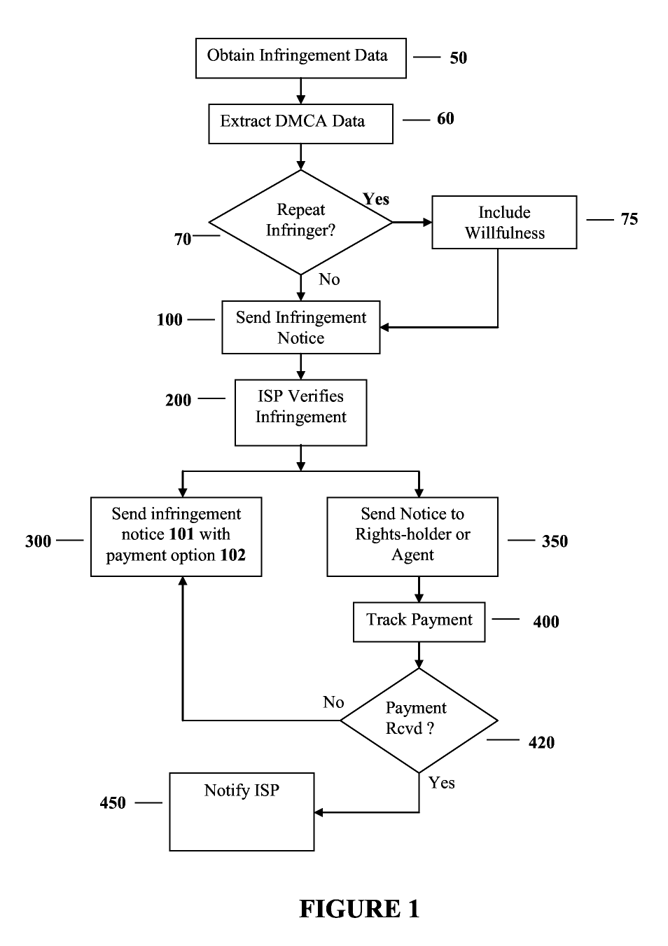

Turning to FIG. 1, one of the first steps involved in enforcing copyrights is determining if a copyright infringement has occurred. The techniques for determining infringement are well known in the art. Those who make copies of infringing digital data are required to participate in the “swarm.” That is, once a user downloads copyrighted material, he obtains the copyrighted data without paying any royalty fees. In exchange for that gift, he must, himself, become a distributor of the illegally obtained copyrighted data. This is known as “seeding” and “leaching.” Prior art patents, such as U.S. Pat. No. 7,730,176 and U.S. Pat. No. 7,716,324, both entitled “Identification and Tracking of Digital Content Distributors of Wide Area Networks,” and both herein incorporated by reference in their entirety, describe one way of tracking infringers of copyrighted digital material on the Internet. Those skilled in the art will recognize that web crawling, identification, and “memory scraping” techniques can be accomplished in any number of ways. In a BitTorrent network, for example, a Torrent Monitor could be used to determine a unique user IP address and other identifying information that could be parsed out of a Torrent Log into SQL data. This SQL data would enable an ISP to locate the individual copyright infringer.

A large scale flow chart of the invention, which will be discussed in further detail below, is shown in FIG. 1. According to one embodiment of the present invention, a rights-holder or its agent can obtain 50 infringement information for copyrighted material that has been illegally shared or downloaded from a P2P or other network. This information can be obtained 50 using any of the aforementioned techniques or others known to those skilled in the art. When the rights-holder or its agent obtains 50 infringement information, it extracts 60 DMCA data 115 that is legally sufficient under the DMCA to send an infringement notice 101 to an ISP of the individual infringer.

The infringement data 115 comprises metadata uniquely identify the infringed copyrighted material as well as when the copyright material was downloaded, and the IP address to which the copyrighted material was downloaded. Prior to sending 100 the infringement notice 101, the rights-holder or its agent could determine 70 from the infringement data 115 if the IP address corresponding to the infringement is a repeat infringer. This determination could be performed by cross-correlating the IP address with the infringement data 115 on case-by-case basis to determine 70 if that IP address appears within an infringement database maintained by the rights-holder or its agent. If the rights-holder or its agent determines 70 that the infringer is a repeat infringer, it can optionally include 75 language in the infringement notice 101 informing the infringer of his willful infringement and the consequences, both monetary, i.e., the exposure to $150,000 in damages per infringement, and the risk of a loss of Internet service if he does not pay for the copyright material by utilizing the payment option 102.

In FIG. 1, once the rights-holder or its agent obtains 50 sufficient information to uniquely identify an infringement, if sends 100 an infringement notice 101 to an ISP. In one embodiment, the rights-holder could have obtained 50 this information on its own, or by hiring an agent to protect its copyrighted material, using any of the techniques discussed above or by other techniques known to those skilled in the art.

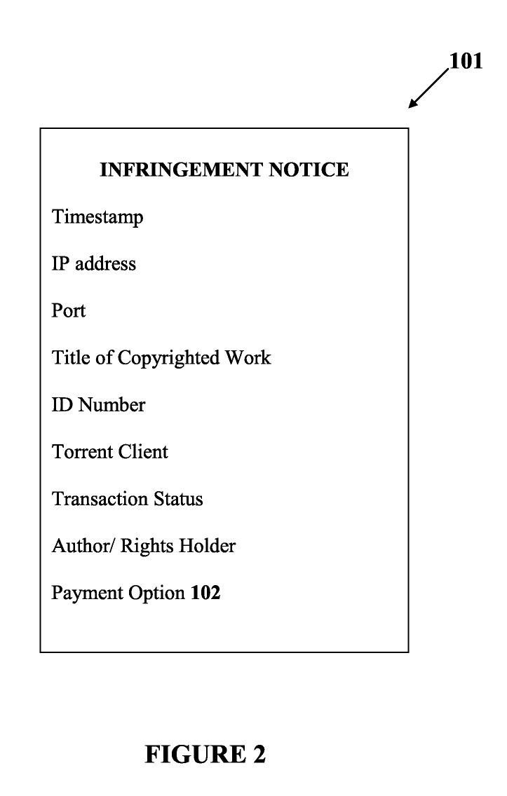

FIG. 2 shows an exemplary embodiment of the type of information that could be sent 100 to an ISP in an infringement notice 101. The information shown in the infringement notice 101 of FIG. 2, which can be sent to an ISP via email, is the information that is necessary to be sent 100 to an ISP under the DMCA. In this embodiment, an ISP will, upon receiving the information contained in the infringement notice 101, correlate that information with information it has stored in its router logs in order to verify 200 that a copyright infringement has occurred.

The present invention seeks to create a collections model that is fan-friendly. Historically, rights-holders have sued fans under DMCA laws to collect revenue or have sent notices to infringers that have largely been ignored. The present invention employs an embodiment where the infringement notice 101 includes a payment option 102 for the infringer, whereby he or she can pay a modest sum to reconcile the copyright infringement.

The payment option 102 could be facilitated by allowing the infringer to click on a link to a rights-holder or its agent's website and to surrender payment via credit card, PayPal, or similar well known online payment methods. In this embodiment, the ISP may be compensated with some portion of the revenue collected from infringers when they opt to utilize the payment option 102 in lieu of risking being sued for copyright infringement or having their Internet service disabled for willfully infringing copyrights. Additionally, rights-holders can recoup reasonable licensing fees for their copyrighted work without having to incur the substantial costs, risks, and negative publicity of suing fans of their copyrighted works.

In an alternate embodiment for notifying an ISP, an infringement notice 101 and a payment option 102 can be sent to an ISP abuse contact handle, which is registered with its American Registration of Internet Numbers (“ARIN”) system. This embodiment has the advantage of reducing the influx of emails that are received by ISPs and of speaking to ISPs on the network that they use to communicate with one another. In this embodiment, the rights-holder or its agent would obtain 50 the Internet address of the specific ISP associated with the infringer. This information is publicly available and could be gleaned from the information used to determine that an individual had illegally downloaded copyrighted material. Generating infringement notices 101 in this embodiment would therefore require the additional step of determining the unique AKIN ISP address for the relevant ISP on an infringement-by-infringement basis. Those skilled in the art will appreciate that this additional step is de minimus because the rights-holder or its agent would have already had to determine which ISP to send an email in the prior embodiment in order to offer a payment option 102 to its client. This embodiment also includes a payment option 102 whereby the infringer can click on a link to a rights-holder's or its agent's website to reconcile payment for the copyrighted material. Here to, an ISP could be compensated by receiving some portion of payments made when utilizing this embodiment.

Turning back to FIG. 1, once an ISP receives an infringement notice 101 with a payment option 102, it must verify 200 that an infringement actually occurred. The ISP performs this step by correlating the information contained in the infringement notice 101 with its router logs. Once infringement has been verified 200, the ISP sends 300 the infringement notice 101 and a payment option 102 to its customer, as well as sending 350 a notice to the rights-holder or its agent confirming transmission of the infringement notice 101 and the payment option 102.

Once the rights-holder or its agent receives the transmission sent 350 by the ISP, it creates an entry in its payment tracking system to track 400 when payment is received for each infringement notice sent. If payment is received 420 according to the payment option 102, the rights-holder or its agent can notify 450 the ISP that payment has been received for the copyright infringement and all further collection efforts should cease. If payment is not received under the payment option 102, the rights-holder or its agent notifies the ISP after a suitable amount of time to resend 300 a notice optionally escalating payment collection efforts.

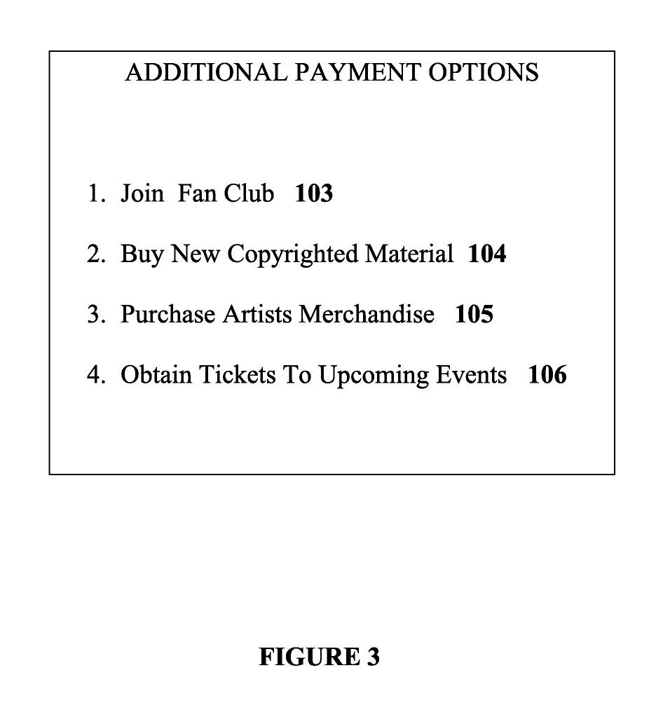

In alternate embodiments, the payment option 102 could include a purchase of additional items in lieu of obtaining a reasonable royalty for the infringement. FIG. 3 depicts a list of additional payment options for infringers in lieu of paying a royalty for the infringement. For example, infringers could be offered the opportunity to join 103 a fan club, buy 104 a new album, movie, television episode image, or book, purchase 105 artist memorabilia such as a t-shirt, backpack, key chain, or similar item, or obtain 106 tickets for an upcoming concert, performance, reading or artistic showing.

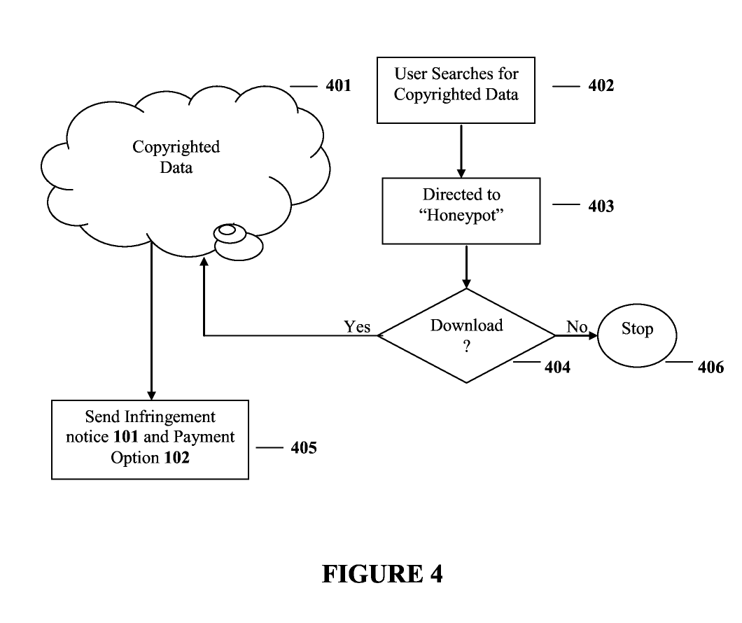

In a yet alternative embodiment, depicted in FIG. 4, a rights-holder or its agent could participate in the “swarm.” In this embodiment, a rights-holder or its agent could establish a file-sharing network 401, or other source housing transferrable data, where it monitor's the rights-holder's copyrighted material. In this embodiment, the rights-holder or its agent creates a “honey-pot” attracting infringers to its site. In this embodiment, a would-be infringer thinks that she will be downloading copyrighted digital content without paying a royalty. This copyrighted material could be placed by a rights-holder or its agent on a cloud or similar network. A would-be infringer could search 402 for music or other copyrighted information he seeks to download for free. Upon performing this search 402, the would-be infringer is directed to 403 the rights-holder's or its agent's site. Once at the rights-holder's or its agent's site, the would-be infringer is provided 404 with the option to download copyrighted material for free. If the would-be infringer does download the copyrighted material, the rights-holder or its agent can send 405 an infringement notice 101 with a payment option 102 directly to the infringer. If the user does not download copyrighted material, there is no infringement to protect and the invention herein disclosed stops 406.

In this embodiment, and all embodiments described herein, it is intended that the payment option 102 be a fan-friendly way of allowing fans of movies, music, art, and books to obtain access to copyrighted material while simultaneously compensating artists for their creativity and the work that goes into creating their copyrighted material. In this spirit, the payment options 102 provided to infringers could be a reasonable monetary amount, or could encompass friend recommendations for a fan club, ticket purchases for upcoming concerts, opening events or theater productions, and similar payment options that take into account fans budgets and artists desires regarding their copyrighted material.

While the embodiments disclosed herein have been directed mainly to file sharing applications currently present on computer-based networks, those skilled in the art will readily recognize how these embodiments could be used in other mediums such as social networking sites, mobile applications, technologies such as drop ship, Bump, Shake and Balance. Although each of these and similar technologies will have its own online or offline means of transferring copyrighted material, the embodiments disclosed herein could readily be adapted to these technologies by one skilled in the art.

What is claimed is:

1. A method of obtaining compensation for copyright infringement comprising the steps of:
a. obtaining infringement data;
b. extracting infringement information from the infringement data;
c. sending an infringement notice to an Internet Service Provider, wherein the Internet Service Provider verifies that an infringer has committed copyright infringement based upon the infringement data that was provided to the Internet Service Provider; and
d. sending a notice to the infringer regarding the infringement information, wherein the notice includes a payment option for reconciling the copyright infringement.

2. The method of claim 1 further comprising the step of receiving payment for the copyright infringement.

3. The method of claim 1 wherein the infringement notice includes a payment option to reconcile the copyright infringement.

4. The method of claim 1 further comprising the step of determining if a copyright infringer is a repeat infringer.

5. The method of claim 4 further comprising including a warning in the infringement notice regarding willful copyright infringement.

6. The method of claim 1 further comprising the step of sending a notice to the rights-holder regarding notice having been sent to the infringer.

7. The method of claim 6 further comprising the step of tracking whether the infringer has paid for the copyright infringement.

8. The method of claim 7 further comprising the step of sending a message to the Internet Service Provider depending on whether payment has been received for the infringement, said message comprising either a notice to escalate collection efforts or notification that payment has been received.

9. The method of claim 1 wherein the payment option includes one of the set of: paying a royalty fee for a copyright infringement, purchasing a membership to a fan club of the copyright holder, purchasing merchandise from the copyright holder, or purchasing a ticket to an upcoming event related to a copyright holder.

10. A method of obtaining payment for copyright infringement comprising the steps of:
a. establishing a file-sharing network containing copyrighted information thereon;
b. capturing infringement data when a user downloads copyrighted information from the file-sharing network; and
c. sending an infringement notice to the user offering a payment option in exchange for having obtained copyrighted information.

11. A computer-readable storage medium containing a set of instructions for a general purpose computer, the set of instructions comprising:
a. obtaining infringement data;
b. extracting infringement information from the infringement data;
c. sending an infringement notice to an Internet Service Provider, wherein the Internet Service Provider verifies that an infringer has committed copyright infringement based upon the infringement data that was provided to the Internet Service Provider; and
d. sending a notice to the infringer regarding the infringement information, wherein the notice includes a payment option for reconciling the copyright infringement.

12. A computer-readable storage medium containing a set of instructions for a general purpose computer, the set of instructions comprising:
a. establishing a file-sharing network containing copyrighted information thereon;
b. capturing infringement data when a user downloads copyrighted information from the file-sharing network; and
c. sending an infringement notice to the user offering a payment option in exchange for having obtained copyrighted information.
